(19) United States
(12) Patent Application Publication
(10) Pub. No.: US 2026/0300212 A1
(43) Pub. Date: Oct. 1, 2026

(54) DEVICE, SYSTEM AND METHODS FOR DRIVING A COMMUNICATION RECEIVER

(71) Applicant: Microchip Technology Inc., Chandler, AZ (US)

(72) Inventor: Avinash Halageri, Bangalore (IN)

(73) Assignee: Microchip Technology Inc., Chandler, AZ (US)

(21) Appl. No.: 19/207,491

(22) Filed: May 14, 2025

(30) Foreign Application Priority Data
Mar. 31, 2025 (IN) 202511032121

(51) Int. Cl. G06F 13/42

(52) U.S. Cl. CPC G06F 13/4282; G06F 2213/0012

(57) ABSTRACT

A system includes an input pad and an output pad. A data capture circuit may receive a signal from the input pad, and may output the received signal to a data processing circuit which may convert the received signal into an output. An output driver may be coupled to the data capture circuit, and a controller circuit may configure the output driver in one or more polarity modes, the polarity modes to enable the output driver to drive a signal to the data capture circuit. In this manner, a functional safety diagnostic test may be performed without requiring an external driver to drive a signal onto the input pad.

### PRIORITY

This application claims priority to commonly owned Indian Patent Application No. 202511032121 filed on Mar. 31, 2025, the entire contents of which are hereby incorporated by reference for all purposes.

### FIELD OF THE INVENTION

The present disclosure relates to a device, system and method for driving a communication receiver, more specifically to a device, system and method for driving a Universal Asynchronous Receiver Transmitter (UART) with an internal driver for performing functional safety diagnostics.

### BACKGROUND

In automotive systems, functional safety diagnostic tests may be performed on electronic components of the system. For a communication receiver, one such functional safety diagnostic test may send a frame of data to the receiver to confirm the frame of data is properly received at the receiver. Such a functional safety diagnostic test may detect faults in the receiver. A driver circuit may generate the frame of data and send the frame of data to the communication receiver.

In cases of failure, it can be difficult to determine the source of the failure. The driver circuit may have a failure which results in the frame of data being sent improperly, or the receiver may have a failure.

There is a need for devices, systems and methods to perform functional safety diagnostic tests on communication receivers to robustly identify faults in the communication receiver.

### SUMMARY

The examples herein enable devices, systems and methods for driving a communication receiver as part of a functional safety diagnostic test.

According to one aspect, a device includes a data capture circuit receives a primary input signal and an auxiliary input signal. The device includes a data processing circuit to receive an output of the data capture circuit. The device includes an output driver coupled to an output pad and coupled to the data capture circuit. In operation, a controller circuit configures the output driver in a polarity mode and drives the auxiliary input signal from the output driver to the data capture circuit based on the polarity mode.

Aspects as in the preceding paragraph provide a device, wherein the output of the data capture circuit comprises a serial data input, and wherein the data processing circuit comprises a shift register to convert a serial data input to a parallel data word.

Aspects as in one of the preceding two paragraphs provide a device, wherein the controller circuit is to configure the output driver in a first polarity mode to drive a first logic signal to the auxiliary input signal and the controller circuit is to configure the output driver in a second polarity mode to drive a second logic value to the auxiliary input signal.

Aspects as in one of the preceding three paragraphs provide a device, wherein the output driver is to be configured in the first polarity mode to drive a logic high value to the auxiliary input signal.

Aspects as in one of the preceding four paragraphs provide a device, wherein the output driver is to be configured in the first polarity mode to drive a logic low value to the auxiliary input signal.

Aspects as in one of the preceding five paragraphs provide a device, wherein the output driver is to be configured in the second polarity mode to drive a logic high value to the auxiliary input signal.

Aspects as in one of the preceding six paragraphs provide a device, wherein the output driver is to be configured in the second polarity mode to drive a logic low value to the auxiliary input signal.

Aspects as in one of the preceding seven paragraphs provide a device, wherein the data capture circuit is to receive a Universal Asynchronous Receiver-Transmitter (UART) input signal and the output driver to transmit a UART signal to the auxiliary input signal.

According to one aspect, a system includes a microcontroller coupled to a Universal Asynchronous Receiver-Transmitter (UART), the UART includes a data capture circuit to receive a UART input signal and an auxiliary input signal. The UART also includes a data processing circuit to receive an output of the data capture circuit and to generate an output signal. The UART also includes an output driver coupled to an output pad and to the data capture circuit. In operation the microcontroller configures the output driver in one or more polarity modes and drives the auxiliary input signal from the output driver to the data capture circuit as part of a functional safety diagnostic test. The microcontroller may receive input from the data processing circuit.

Aspects as in the preceding paragraph provide a system, wherein the microcontroller is to configure the output driver in a first polarity mode to drive a first logic signal to the auxiliary input signal and the microcontroller to configure the output driver in a second polarity mode to drive a second logic signal to the auxiliary input signal.

Aspects as in one of the preceding two paragraphs provide a system, wherein the first polarity mode is to configure the output driver to drive a logic high value to the auxiliary input signal.

Aspects as in one of the preceding three paragraphs provide a system, wherein the first polarity mode is to configure the output driver to drive a logic low value to the auxiliary input signal.

Aspects as in one of the preceding four paragraphs provide a system, wherein the second polarity mode is to configure the output driver to drive a logic high value to the auxiliary input signal.

Aspects as in one of the preceding five paragraphs provide a system, the second polarity mode to configure the output driver to drive a logic low value to the auxiliary input signal.

Aspects as in one of the preceding six paragraphs provide a system, the microcontroller to determine a failure condition based on the output signal from the data processing circuit not matching an expected value.

According to one aspect, a method includes steps of: configuring a receiver in a first polarity mode, the first polarity mode to drive a first binary signal to a data capture circuit, configuring the receiver in a second polarity mode, the second polarity mode to drive a second binary signal to the data capture circuit, the second binary signal the logical inverse of the first binary signal, configuring, over a predetermined time, the receiver in a combination of first polarity modes and second polarity modes, the combination to transmit a data word, capturing the data word at the data capture circuit, and comparing the captured data word against an expected data word to generate a comparison output.

Aspects as in the preceding paragraph provide a method, wherein the first polarity mode is to configure the receiver to drive a logic high value to the data capture circuit.

Aspects as in one of the preceding two paragraphs provide a method, wherein the second polarity mode is to configure the receiver to drive a logic low value to the data capture circuit.

Aspects as in one of the preceding three paragraphs provide a method, wherein the comparison output is to determine a failure in a functional safety diagnostic test based on the captured data word not matching the expected data word.

Aspects as in one of the preceding four paragraphs provide a method, wherein the data word comprises a Universal Asynchronous Receiver Transmitter (UART) data word.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 illustrates one of various examples of a device for driving a communication receiver.

FIG. 2 illustrates another example of a device for driving a communication receiver.

FIG. 3 illustrates waveforms for transmission of a serial data word.

FIG. 4 illustrates a method for driving a receiver.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DETAILED DESCRIPTION

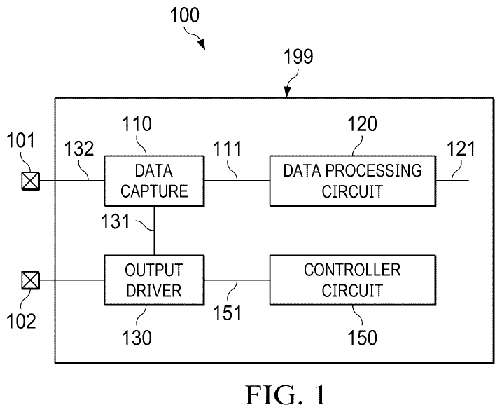

FIG. 1 illustrates one of various examples of a device 100 for driving a communication receiver.

Device 100 may include communication receiver 199. Device 100 may include an input pad 101 and an output pad 102. In operation, data capture circuit 110 may receive a signal at an input of data capture circuit 110 and may output signal 111. An input of data capture circuit 110 may be generated by an external circuit coupled to input pad 101 and input to data capture circuit 110 via primary input signal 132. An input of data capture circuit 110 may be generated by output driver 130 and may be input to data capture circuit 110 via auxiliary input signal 131.

Primary input signal 132 and auxiliary input signal 131 may be coupled together internal to data capture circuit 110 and may comprise a data input to data capture circuit 110. In one of various examples, primary input signal 132 may be undriven, and the data input to data capture circuit 110 may be provided by auxiliary input signal 131.

Data processing circuit 120 may receive signal 111 from data capture circuit 110 and may generate output signal 121. Output signal 121 may be a parallel data word. Output signal 121 may be compared against an expected signal. The comparison may generate a failure condition based on the result of the comparison.

Signal 111 may be an output of data capture circuit 110. Signal 111 may be a serial data signal and may be a serial data input to data processing circuit 120. Data processing circuit 120 may be a shift register or may be another type of data processing circuit not specifically mentioned.

Output driver 130 may drive a signal onto output pad 102. Communication receiver 199 may include one or more polarity modes. As one of various examples, a first polarity mode may drive a logic high signal to auxiliary input signal 131, and a second polarity mode may drive a logic low signal to auxiliary input signal 131 during. Controller circuit 150 may enable and disable the one or more polarity modes over communication bus 151. The one or more polarity modes may be enabled by a register setting or by a software programmable value.

In operation, in one of various examples, no external signal may be driven onto input pad 101. While no external signal is driven onto input pad 101, circuitry within communication receiver 199 may drive the auxiliary input signal 131 to drive an input of data capture circuit 110 to a known voltage. In the example illustrated in FIG. 1, output driver 130 may drive auxiliary input signal 131 to a known voltage, but this is not intended to be limiting. Other circuitry may drive auxiliary input signal 131.

Receiver 199 may be configured in one or more polarity modes. In a first polarity mode, the idle state of primary input signal 132 may be a logic high level, and output driver 130 may drive a logic high value to auxiliary input signal 131. In a second polarity mode, the idle state of primary input signal 132 may be a logic low level, and output driver 130 may drive a logic high value to auxiliary input signal 131.

In this manner, a signal may be driven to an input of data capture circuit 110 based on changing from the first polarity mode to the second polarity mode. A UART signal may be driven to an input of data capture circuit 110.

During a functional safety diagnostic test, the first polarity mode and the second polarity mode may be used to drive a data frame to data capture circuit 110 to perform a functional safety diagnostic test without requiring an external driver. The data frame driven to data capture circuit 110 may be a UART data frame. The UART data frame may test that communication receiver 199 may receive a UART data frame with no errors.

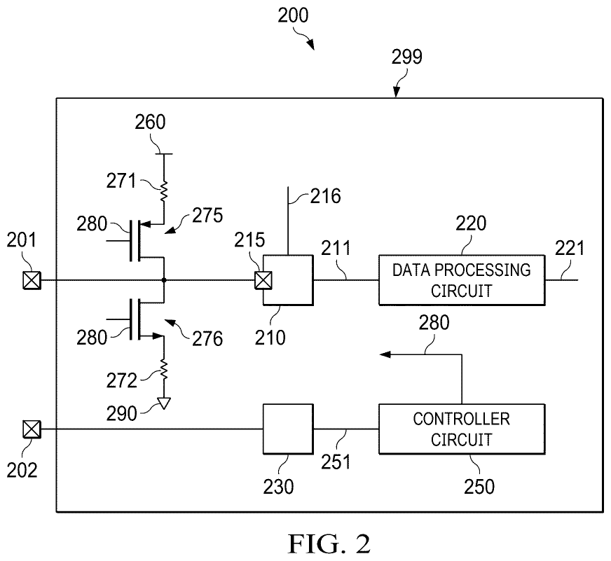

FIG. 2 illustrates another example of a device 200 for driving a communication receiver. Device 200 may be part of a microcontroller.

Device 200 may include communication receiver 299. Device 200 may include input pad 201 and output pad 202. In operation, data capture circuit 210 may receive a signal at data capture input 215 and may generate signal 211. Data capture circuit may include flip-flops or other data capture elements to capture a signal based on data capture input 215 and clock signal 216.

Data processing circuit 220 may receive signal 211 from data capture circuit 210 and may generate output signal 221. Output signal 221 may be compared against an expected value. Signal 211 may be an output of data capture circuit 210. Signal 211 may be a serial data signal. Data processing circuit 220 may include a shift register or may include another type of data processing circuit not specifically mentioned.

Device 200 may include supply 260. Supply 260 may be coupled to pull-up resistor 271. Supply 260 may be selectively coupled to data capture input 215 by pull-up device 275. Device 200 may include ground connection 290. Ground connection 290 may be coupled to pull-down resistor 272. Ground connection 290 may be selectively coupled to data capture input 215 by pull-down device 276.

In operation, controller circuit 250 may configure device 200 in a first polarity mode, and the voltage on polarity mode signal 280 may be a logic low value. Polarity mode signal 280 may be coupled to a gate node of pull-up device 275. Polarity mode signal 280 may be coupled to a gate node of pull-down device 276. Pull-up device 275 may be a p-channel metal-oxide semiconductor (PMOS) device and may be enabled by a logic low value on polarity mode signal 280. Pull-up device 275 may couple supply 260 to data capture input 215 via pull-up resistor 271. While input pad 201 is not driven by an external circuit, data capture input 215 may be held at a logic high level by the connection to supply 260 via pull-up device 275 and pull-up resistor 271.

In operation, controller circuit 250 may configure device 200 in a second polarity mode, and the voltage on polarity mode signal 280 may be a logic high value. Pull-down device 276 may be an n-channel metal-oxide semiconductor (NMOS) device and may be enabled by a logic high value on polarity mode signal 280. Pull-down device 276 may couple ground connection 290 to data capture input 215 via pull-down resistor 272. While input pad 201 is not driven by an external circuit, data capture input 215 may be held at a logic low level by the connection to ground connection 290 via pull-down device 276 and pull-down resistor 272.

In operation, controller circuit 250 may configure device 200 in a first polarity mode to drive a logic high value to data capture input 215 and may configure device 200 in a second polarity mode to drive a logic low value to data capture input 215. By programming device 200 in a first polarity mode and a second polarity mode in a predetermined sequence, a serial data word may be transmitted to data capture circuit 210. The serial data word may be a UART data word, or may be a data word based on another communication protocol.

Supply 260, pull-up resistor 271, pull-up device 275, pull-down device 280, pull-down resistor 272 and ground connection 290 may function as an internal driver to drive a voltage onto data capture input 215 while input pad 201 is not driven.

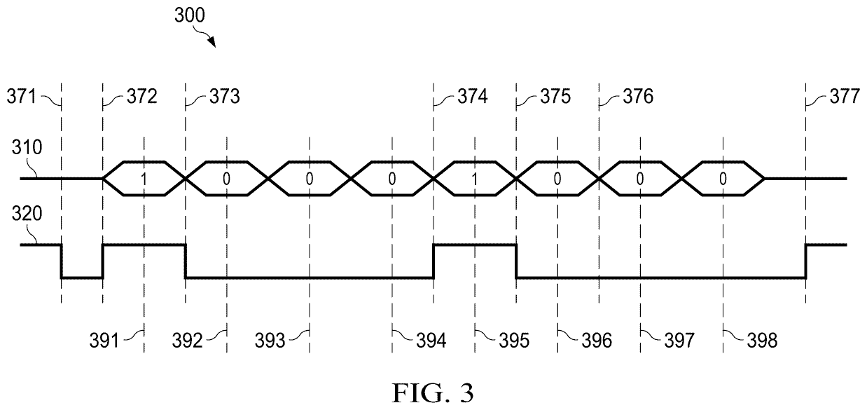

FIG. 3 illustrates waveforms 300 for transmission of a serial data word to a communication receiver.

Trace 310 may represent data captured in data capture circuit 210. Trace 310 may represent signal 211 of data capture circuit 210. Trace 320 may represent an input signal. Trace 320 may represent input signal 232 as described and illustrated in reference to FIG. 2.

Initially, the communication receiver may be configured in a first polarity mode. Trace 320 may be a logic high value. Trace 320 may be driven to a logic high value by supply 260, pull-up resistor 271, and pull-up device 275 as described and illustrated in reference to FIG. 2.

At time 371, the communication receiver may be configured in a second polarity mode. In the second polarity mode, trace 320 may be a logic low value. Trace 320 may be driven to a logic low value by ground connection 290, pull-down resistor 272, and pull-down device 276 as described and illustrated in reference to FIG. 2.

At time 372, the communication receiver may be configured in the first polarity mode. In the first polarity mode, trace 320 may be a logic high value. Trace 320 may be driven to a logic high value by supply 260, pull-up resistor 271, and pull-up device 275 as described and illustrated in reference to FIG. 2.

At time 391, the value of trace 320 may be sampled. Trace 320 may be sampled in data capture circuit 210 as described and illustrated in reference to FIG. 2. In the example illustrated in FIG. 3, a value of logic one may be sampled, but this is not intended to be limiting.

At time 373, the communication receiver may be configured in the second polarity mode. In the second polarity mode, trace 320 may be a logic low value. Trace 320 may be driven to a logic low value by ground connection 290, pull-down resistor 272, and pull-down device 276 as described and illustrated in reference to FIG. 2.

At time 392, the value of trace 320 may be sampled. Trace 320 may be sampled in data capture circuit 210 as described and illustrated in reference to FIG. 2. In the example illustrated in FIG. 3, a value of logic zero may be sampled, but this is not intended to be limiting.

At time 393, the value of trace 320 may be sampled. Trace 320 may be sampled in data capture circuit 210 as described and illustrated in reference to FIG. 2. In the example illustrated in FIG. 3, a value of logic zero may be sampled, but this is not intended to be limiting.

At time 394, the value of trace 320 may be sampled. Trace 320 may be sampled in data capture circuit 210 as described and illustrated in reference to FIG. 2. In the example illustrated in FIG. 3, a value of logic zero may be sampled, but this is not intended to be limiting.

At time 374, the communication receiver may be configured in the first polarity mode. In the first polarity mode, trace 320 may be a logic high value. Trace 320 may be driven to a logic high value by supply 260, pull-up resistor 271, and pull-up device 275 as described and illustrated in reference to FIG. 2.

At time 395, the value of trace 320 may be sampled. Trace 320 may be sampled in data capture circuit 210 as described and illustrated in reference to FIG. 2. In the example illustrated in FIG. 3, a value of logic one may be sampled, but this is not intended to be limiting.

At time 375, the communication receiver may be configured in the second polarity mode. In the second polarity mode, trace 320 may be a logic low value. Trace 320 may be driven to a logic low value by ground connection 290, pull-down resistor 272, and pull-down device 276 as described and illustrated in reference to FIG. 2.

At time 396, the value of trace 320 may be sampled. Trace 320 may be sampled in data capture circuit 210 as described and illustrated in reference to FIG. 2. In the example illustrated in FIG. 3, a value of logic zero may be sampled, but this is not intended to be limiting.

At time 397, the value of trace 320 may be sampled. Trace 320 may be sampled in data capture circuit 210 as described and illustrated in reference to FIG. 2. In the example illustrated in FIG. 3, a value of logic zero may be sampled, but this is not intended to be limiting.

At time 398, the value of trace 320 may be sampled. Trace 320 may be sampled in data capture circuit 210 as described and illustrated in reference to FIG. 2. In the example illustrated in FIG. 3, a value of logic zero may be sampled, but this is not intended to be limiting.

At time 377, the communication receiver may be configured in the first polarity mode. In the first polarity mode, trace 320 may be a logic high value. Trace 320 may be driven to a logic high value by supply 260, pull-up resistor 271, and pull-up device 275 as described and illustrated in reference to FIG. 2.

As illustrated in FIG. 3, a communication receiver may be configured in a first polarity mode and a second polarity mode in a predetermined pattern to transmit a serial data stream to a data capture circuit. The example illustrated in FIG. 3 transmits an 8-bit word corresponding to value 10001000 in binary, but this is not intended to be limiting.

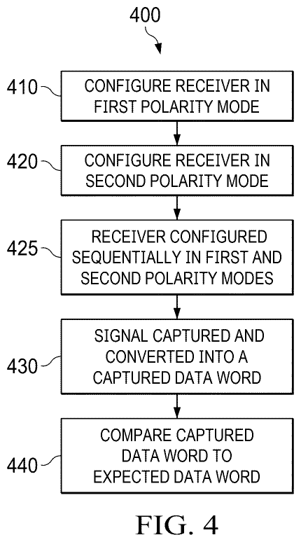

FIG. 4 illustrates a method for driving a receiver. The receiver may be a communication receiver as described and illustrated in reference to FIG. 1.

At operation 410, a receiver may be configured in a first polarity mode. In the first polarity mode, an auxiliary input signal may be driven with a first binary signal when a primary input signal is idle. The primary input signal may be idle when the primary input signal is not driven by an external circuit.

At operation 420, the receiver may be configured in a second polarity mode. In the first polarity mode, an auxiliary input signal may be driven with a second binary signal when a primary input signal is idle. The primary input signal may be idle when the primary input signal is not driven by an external circuit. The second binary signal may be the logical inverse of the first binary signal.

At operation 425, the receiver may be sequentially configured in a sequence of the first polarity mode and the second polarity mode. As one of various examples, the receiver may be sequentially configured in the first polarity mode and the second polarity mode as described and illustrated in reference to FIG. 3.

At operation 430, a data capture circuit may capture the signal at the auxiliary input signal and may convert the captured signal into a captured data word.

At operation 440, a data processing circuit may compare the captured data word to an expected data word and may determine a pass/fail condition. If the captured data word matches the expected data word, a pass condition may be determined. If the captured data word does not match the expected data word, a failure condition may be determined.

The method illustrated in FIG. 4 may be part of a function safety diagnostic test. A data word may be transmitted to the auxiliary input signal of the receiver. If the data word is received as expected, the functional safety diagnostic test may result in a passing condition. If the data word is not received as expected, the functional safety diagnostic test may result in a failing condition. In the manner, a functional safety diagnostic test may be performed on a receiver without any external components.

In one of various examples, a UART data word may be transmitted to the auxiliary input signal of the receiver. In one of various examples, the receiver may comprise a UART transceiver.

Although examples have been described above, other variations and examples may be made from this disclosure without departing from the spirit and scope of these disclosed examples.

1. A device comprising:
a data capture circuit to receive a primary input signal and an auxiliary input signal;
a data processing circuit to receive an output of the data capture circuit; and
an output driver coupled to an output pad and coupled to the data capture circuit,
wherein a controller circuit is to configure the output driver in a polarity mode and is to drive the auxiliary input signal from the output driver to the data capture circuit based on the polarity mode.

2. The device as claimed in claim 1, wherein the output of the data capture circuit comprises a serial data input, and wherein the data processing circuit comprises a shift register to convert a serial data input to a parallel data word.

3. The device as claimed in claim 1, wherein the controller circuit is to configure the output driver in a first polarity mode to drive a first logic signal to the auxiliary input signal and the controller circuit is to configure the output driver in a second polarity mode to drive a second logic value to the auxiliary input signal.

4. The device as claimed in claim 3, wherein the output driver is to be configured in the first polarity mode to drive a logic high value to the auxiliary input signal.

5. The device as claimed in claim 3, wherein the output driver is to be configured in the first polarity mode to drive a logic low value to the auxiliary input signal.

6. The device as claimed in claim 3, wherein the output driver is to be configured in the second polarity mode to drive a logic high value to the auxiliary input signal.

7. The device as claimed in claim 3, wherein the output driver is to be configured in the second polarity mode to drive a logic low value to the auxiliary input signal.

8. The device as claimed in claim 1, wherein the data capture circuit is to receive a Universal Asynchronous Receiver-Transmitter (UART) input signal and the output driver to transmit a UART signal to the auxiliary input signal.

9. A system comprising:
a microcontroller coupled to a Universal Asynchronous Receiver-Transmitter (UART), the UART comprising:
a data capture circuit to receive a UART input signal and an auxiliary input signal;
a data processing circuit to receive an output of the data capture circuit and to generate an output signal; and
an output driver coupled to an output pad and to the data capture circuit,
wherein the microcontroller to configure the output driver in one or more polarity modes to drive the auxiliary input signal from the output driver to the data capture circuit as part of a functional safety diagnostic test and the microcontroller to receive input from the data processing circuit.

10. The system as claimed in claim 9, wherein the microcontroller is to configure the output driver in a first polarity mode to drive a first logic signal to the auxiliary input signal and the microcontroller to configure the output driver in a second polarity mode to drive a second logic signal to the auxiliary input signal.

11. The system as claimed in claim 10, wherein the first polarity mode is to configure the output driver to drive a logic high value to the auxiliary input signal.

12. The system as claimed in claim 10, wherein the first polarity mode is to configure the output driver to drive a logic low value to the auxiliary input signal.

13. The system as claimed in claim 10, wherein the second polarity mode is to configure the output driver to drive a logic high value to the auxiliary input signal.

14. The system as claimed in claim 10, the second polarity mode to configure the output driver to drive a logic low value to the auxiliary input signal.

15. The system as claimed in claim 9, the microcontroller to determine a failure condition based on the output signal from the data processing circuit not matching an expected value.

16. A method comprising:
configuring a receiver in a first polarity mode, the first polarity mode to drive a first binary signal to a data capture circuit;
configuring the receiver in a second polarity mode, the second polarity mode to drive a second binary signal to the data capture circuit, the second binary signal the logical inverse of the first binary signal;
configuring, over a predetermined time, the receiver in a combination of first polarity modes and second polarity modes, the combination to transmit a data word;
capturing the data word at the data capture circuit; and
comparing the captured data word against an expected data word to generate a comparison output.

17. The method as claimed in claim 16, wherein the first polarity mode is to configure the receiver to drive a logic high value to the data capture circuit.

18. The method as claimed in claim 16, wherein the second polarity mode is to configure the receiver to drive a logic low value to the data capture circuit.

19. The method as claimed in claim 16, wherein the comparison output is to determine a failure in a functional safety diagnostic test based on the captured data word not matching the expected data word.

20. The method as claimed in claim 16, wherein the data word comprises a Universal Asynchronous Receiver Transmitter (UART) data word.
